(19) United States
(12) Patent Application Publication
(10) Pub. No.: US 2025/0340702 A1
(43) Pub. Date: Nov. 6, 2025

(54) In-Mold Electronics using Thermosetting Polymers

(71) Applicant: National Technology & Engineering Solutions of Sandia, LLC, Albuquerque, NM (US)

(72) Inventors: Bryan James Kaehr, Albuquerque, NM (US); Samuel Carlos Leguizamon, Albuquerque, NM (US); Hayden Fowler, Albuquerque, NM (US); Mychal S. Taylor, Sandia Park, NM (US); Georgia Elizabeth Kaufman, Albuquerque, NM (US)

(21) Appl. No.: 19/083,517

(22) Filed: Mar. 19, 2025

Related U.S. Application Data
(63) Continuation-in-part of application No. 18/652,310, filed on May 1, 2024.

(51) Int. Cl. C08J 3/075; C08F 232/08

(52) U.S. Cl. CPC C08J 3/075; C08F 232/08; C08J 2345/00

(57) ABSTRACT

In-mold electronics is an innovative approach to the manufacture of 3D circuitry and electronic components. In-mold electronics relies on vacuum forming processes, which are historically to thermoplastics. The present invention is directed to method of vacuum forming using thermoset polymers. Specifically, an ambient polymerization is used to transition a liquid monomeric solution to an elastomeric gel. This free-standing gel can then be vacuum formed to a mold, and the reaction can be completed via a frontal polymerization of the molded gel. Thermoset materials produced with this method have properties that provide benefits over traditionally employed thermoplastic substrates and enable 3D device integration into environmentally demanding architectural, automotive and extraterrestrial structures.

### CROSS-REFERENCE TO RELATED APPLICATIONS

This application is a continuation-in-part of U.S. application Ser. No. 18/652,310, filed May 1, 2024, which claims the benefit of U.S. Provisional Application No. 63/463,485, filed May 2, 2023, both of which are incorporated herein by reference.

### FEDERALLY SPONSORED RESEARCH AND DEVELOPMENT

This invention was made with Government support under Contract No. DE-NA0003525 awarded by the United States Department of Energy/National Nuclear Security Administration. The Government has certain rights in the invention.

### BACKGROUND OF THE INVENTION

Material selection for specific applications necessitates careful consideration of both the required properties and the feasibility of manufacturing for the intended use. Materials with desirable properties (e.g., mechanical strength, chemical resistance, and environmental stability) often come at the expense of manufacturing aims (e.g., energy efficiency, cost effectiveness, environmental friendliness, rapidity, and simplicity). Polymer manufacturing exemplifies this challenge, specifically when considering a choice between thermoplastics and thermosets. See J. P. Pascault and R. J. J. Williams, in Thermosets (Second Edition), pp. 3-34 (2018); and E. N. Peters, in Applied Plastics Engineering Handbook (Second Edition), pp 3-26 (2017). Thermoplastics are thermally processable materials due to their melting behavior and are generally straightforward to manufacture. See M. Garcia and M. L. Robertson, Science 358, 870 (2017). A broad range of thermoplastic materials are available, but they struggle to maintain their properties in extreme environments, such as high temperature. Conversely, thermosets provide desirable properties such as strength, thermal and chemical stability, and creep resistance due to the inclusion of permanent covalent crosslinks. As a result, they are more challenging to process and cannot be thermally reprocessed (i.e., melted) like thermoplastics. Thermosets also often require expensive equipment, such as ovens and autoclaves, and energy-intensive manufacturing processes with significant environmental impact. Balancing manufacturing processes with achievable material properties is crucial for optimizing performance, driving innovation, and ensuring applicability across various industrial sectors.

In-Mold Electronics (IME) is an advanced manufacturing approach to integrate electronic functionality directly into 3D parts, structures, and architectures. See M. Bakr et al., Flex. Print. Electron. 7 (2), (2022); and M. Dyson and I. Al-Dhahir, “In-Mold Electronics 2023-2033”, in IDTechEx Research (2023). IME is a culmination of established processes that include in-mold decoration (IMD), film insert molding (FIM) and printed electronics (PE). Combining traditional electronic functions with molded parts provides greater design freedom for devices and assemblies, and can reduce overall size, weight and power requirements (SWaP), reduce connections between components, and improve ruggedness via all-in-one packaging. As mass produced durable goods such as cars and appliances incorporate ever more sensors, displays, and devices into their products, this manufacturing approach is expected to provide considerable impact to these industries in the coming decades. See M. Dyson and I. Al-Dhahir, “In-Mold Electronics 2023-2033”, in IDTechEx Research (2023).

Currently, IME leverages the melting behavior of thermoplastics to create structural electronics, integrating electrical components and connections into 3D structures through vacuum forming and injection molding. See M. Bakr et al., Flex. Print. Electron. 7, 023001 (2022); and M. Beltrão et al., Polym. Eng. Sci. 62, 967 (2022). Vacuum forming involves heating a thermoplastic sheet until pliable and using a vacuum to conform it to a mold followed by cooling to retain the shape. See C. A. Taylor et al., Polym. Eng. Sci. 32, 1163 (1992). Vacuum forming has many advantages, including low-cost tooling, ease of updates and modifications, rapid turnaround for parts and tooling production, and the ability to produce durable and lightweight parts at affordable prices. IME applies electronic circuits and components to thermoplastic substrates, which are subsequently vacuum formed to create a functional 3D shape. Afterwards, more electronic components can be added, and injection molding can be used to encapsulate the system. See M. Bakr et al., Procedia Manuf. 52, 26 (2020); M. Bakr et al., in 2019 22nd European Microelectronics and Packaging Conference & Exhibition (EMPC), pp. 1-8 (2019); and M. Bakr et al., Flex. Print. Electron. 6, 025007 (2021). IME is relevant in industrial applications, especially in the automotive sector, due to its ability to generate lightweight, space-saving, structural electronics. Currently, IME relies on moldable thermoplastic substrates, such as polycarbonate and polyethylene terephthalate, for vacuum forming. However, thermosets would be advantageous for enhancing the robustness of these components against environmental factors, potentially expanding their use to other industries.

Therefore, the present invention is directed to a method to produce moldable thermoset substrates via vacuum forming for IME applications.

### SUMMARY OF THE INVENTION

The present invention is directed to a method for fabricating an in-mold electronic structure using a thermosetting polymer, comprising providing a resin comprising a metathesis-active olefinic monomer and a latent metathesis catalyst; transitioning the monomer to an elastomeric gel via a ring-opening metathesis polymerization reaction; vacuum forming the elastomeric gel to a mold; and curing the molded gel via a frontal ring-opening metathesis polymerization reaction to provide a thermoset part. For example, the metathesis-active olefinic monomer can comprise dicyclopentadiene or norbornadiene, or derivatives thereof. The resin can further comprise a comonomer, such as norbornene, oxonorbornene, azanorbornene, cyclobutene, cyclooctene, cyclooctadiene, cyclooctatetraene, or derivatives thereof. For example, the latent metathesis catalyst can comprise a thermally latent, photolatent, or inhibited catalyst. For example, the resin can comprise between 0.005 and 0.04 mol % of a thermally latent ruthenium catalyst to provide a sufficient pot life for liquid resin processing, usable gel formation, and adequate working time. The elastomeric gel can have a storage modulus of greater than about 2 kPa to provide a sufficient malleability to vacuum form the elastomeric gel to the mold without rupturing.

To fabricate an IME structure, the method can further comprise patterning one or more metal traces on the elastomeric gel after the transitioning step. For example, the patterning can comprise applying a metal tape to the elastomeric gel, laser cutting a trace design from the metal tape, and removing excess metal tape to leave the one or more metal traces. The one or more metal traces can form an interconnect conductive metal trace having a meander pattern. One or more surface-mount devices can be attached to the thermoset part after the curing step to provide an electrical circuit with the one or more metal traces.

### BRIEF DESCRIPTION OF THE DRAWINGS

The detailed description will refer to the following drawings, wherein like elements are referred to by like numbers.

FIG. 1 illustrates the ambient transition of monomeric dicyclopentadiene (DCPD) to pDCPD gel via ring-opening metathesis polymerization (ROMP), followed by frontal ring-opening metathesis polymerization (FROMP) of the pDCPD gel to form fully cured pDCPD.

FIG. 2 is a graph of tan delta peaks of elastomeric pDCPD gel and fully cured pDCPD obtained via dynamic mechanical analysis (DMA), showing the difference in glass transition temperatures.

FIG. 3 is a schematic illustration of a vacuum forming method of the present invention.

FIG. 4 is a graph showing the rheology of initially monomeric DCPD at ambient conditions with varying ruthenium catalyst loadings.

FIG. 5A is a photograph showing that initial viscoelastic gel formation does not form a free-standing gel. FIG. 5B shows a stand-alone gel after waiting for an appropriate increase in storage modulus.

FIG. 6 shows images of strips with at various times after FROMP is initiated on a strip of gel with a soldering iron. The front traverses the entire strip in 120 s.

FIG. 7A is a graph showing FROMP rate across the gel. FIG. 7B is a graph showing heat of reaction of residual exotherms from differential scanning calorimetry (DSC) measurements over time at varying ruthenium catalyst loadings, with normalized time indicating the time after the gel has reached a storage modulus of 2 kPa, as indicated by rheology from FIG. 4.

FIG. 8 shows photos (top) and forward-looking infrared (FLIR) images (bottom) of vacuum forming and FROMP of pDCPD gels, initiated with a heat gun off-camera as indicated by the waved lines in the upper left image.

FIG. 9 shows pDCPD formed to a variety of shapes, including hills and valleys, a star, and a split flat-flex cable analogue.

FIG. 10A is a thermogravimetric analysis (TGA) spectrum of fully cured pDCPD. The top inset shows vacuum formed stars of thermoplastic PETG and thermoset pDCPD. The bottom inset shows the same vacuum formed stars after spending 1 hour at 300° C. in an argon atmosphere. FIG. 10B shows a representative tensile test curve of fully cured pDCPD. FIG. 10C shows UV-Vis transmission spectrum of fully cured pDCPD.

FIG. 11 shows a method for creating structural electronics from frontally polymerized thermosets.

FIG. 12A shows a mold and trace placement design for a simple battery pack. FIG. 12B is a photo of the molded part with copper traces. FIG. 12C shows the addition of spring contacts and surface mount electronic components to create a functional battery-powered LED circuit operated by a switch.

### DETAILED DESCRIPTION OF THE INVENTION

Thermoset manufacturing often requires energy intensive, expensive, environmentally harmful processes. Comparatively, frontal polymerization offers a unique pathway to rapid, energy-efficient curing for high-performance materials. In frontal polymerization, a reaction front is initiated by localized heating, generating a self-sustaining polymerization wave due to heat released by the exothermic reaction. See B. A. Suslick et al., Chem. Rev. 123, 3237 (2023); J. A. Pojman, in Nonlinear Dynamics with Polymers, pp. 45-67 (2010); J. A. Pojman et al., J. Am. Chem. Soc. 118, 3783 (1996); S. Vyas et al., Compos. Sci. Technol. 198, 108303 (2020); B. McFarland et al., Macromolecules 39, 55 (2006); C. A. Parrinello et al., J. Polym. Sci., Part A: Polym. Chem. 50, 2337 (2012); and J. A. Pojman et al., J. Chem. Soc., Faraday Trans. 92, 2825 (1996). The front propagates through a monomer or oligomer solution, converting the resin mixture into a solid polymer as it advances. This method can significantly reduce curing times, enabling rapid production. Additionally, because the reaction is self-propagating, it requires minimal external energy input, leading to higher energy efficiency and lower energy costs.

Recent work on frontal ring-opening metathesis polymerization (FROMP) shows promise in the manufacture of poly(dicyclopentadiene) (pDCPD), a thermoset derived from an inexpensive byproduct of the oil and gas industry. See J. C. Mol, J. Mol. Catal. A Chem. 213, 39 (2004). pDCPD possesses desirable properties such as high impact resistance, chemical corrosion resistance, high heat deflection temperature, and low shrinkage, making it attractive for industrial applications. See J. C. Mol, J. Mol. Catal. A Chem. 213, 39 (2004); and D. S. Breslow, Prog. Polym. Sci. 18, 1141 (1993). pDCPD is traditionally produced via reaction injection molding, wherein a mold is filled with monomer and the reaction is completed within. See D. S. Breslow, Prog. Polym. Sci. 18, 1141 (1993). In contrast, FROMP enables much more energy- and time-efficient manufacture of the same thermoset polymer. Recent developments in resin stability have enabled processing via direct-ink write (DIW) and manufacture of carbon-fiber reinforced composites, showing promise for industrial capabilities of FROMP. See I. D. Robertson et al., Nature 557, 223 (2018); and O. Davydovich et al., Macromolecules 56, 7543 (2023).

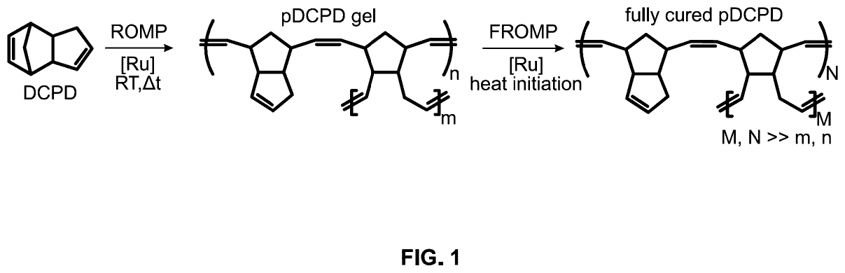

The present invention is directed to a method to vacuum form a ROMP polymer within the gel state followed by FROMP curing of the vacuum-formed gel to achieve manufacturing of bespoke thermosets. As an example, FIG. 1 illustrates the ambient transition of monomeric DCPD to pDCPD gel via ROMP, followed by FROMP of the pDCPD gel to form fully cured pDCPD. However, other metathesis-active olefinic monomers capable of cross-linking, such as norbornadiene, can also be used to form the gel. The resin can include other metathesis-active comonomers, such as norbornene, oxonorbornene, azanorbornene, cyclobutene, cyclooctene, cyclooctadiene, cyclooctatetraene, and derivatives thereof. A thermally latent ruthenium catalyst is shown in this example. However, other latent metathesis catalysts, including thermally latent catalysts, photolatent catalysts, and stabilized (e.g., inhibited) catalyst systems that extend resin stability yet create a large exotherm during frontal polymerization can also be used. See U.S. Pat. No. 11,820,839, which is incorporated herein by reference. Depending on the resin formulation, frontal polymerization can be initiated by heat, photochemically, or via acid or solvent addition. The method is capable of rapidly producing free-standing gels while maintaining reactivity for practical processing times. Vacuum forming and subsequent FROMP of the gel generates thermosets with excellent material properties and benefits over traditionally vacuum-formed thermoplastics. The thermoset can be used as a substrate for thermoformed, functional structural IMEs.

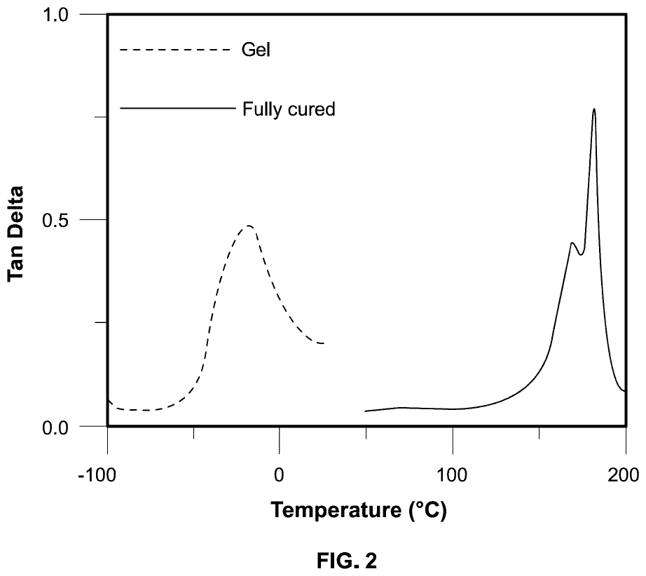

As an example, on addition of a ruthenium metathesis catalyst to a liquid monomeric mixture of primarily DCPD monomer, the monomer gradually reacts at ambient conditions to form a viscoelastic pDCPD gel. The free-standing pDCPD gel can then be vacuum formed to a mold followed by FROMP to lock in the shape and complete curing of the gel. In this way, the material transitions from a flexible, elastomeric gel with a glass transition temperature below room temperature to a fully cured, rigid thermoset with a glass transition temperature above room temperature, as indicated by the tan delta curve from DMA experiments shown in FIG. 2.

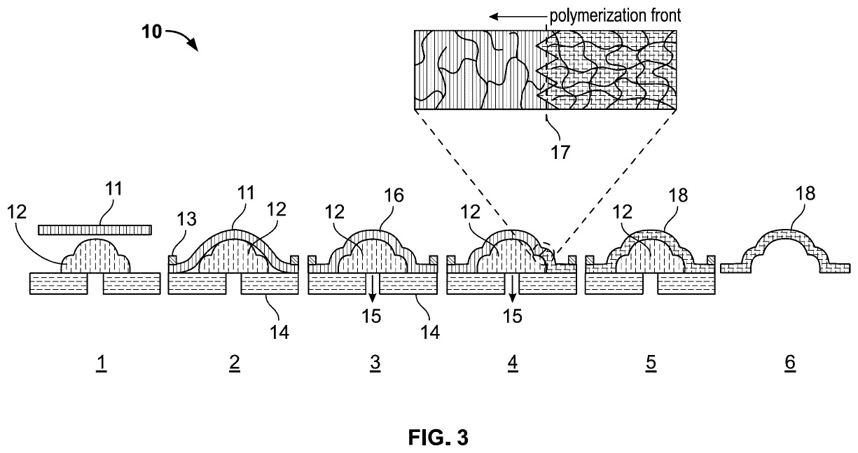

FIG. 3 is schematic illustration of a vacuum forming method 10 of the present invention. A free-standing elastomeric gel 11 of a ROMP polymer and a mold 12 are provided at step 1. At step 2, the gel 11 is flexible and can be placed over the mold 12 and clamped 13 into place on a vacuum forming table 14. At step 3, vacuum 15 is pulled on the table 14 to force the gel 11 against the mold 12, conforming the molded gel 16 to the surface of the mold 12. At step 4, FROMP is initiated locally on the molded gel 16, for example with a heat gun, and the front 17 traverses across the gel, increasing crosslinking in the polymer as the front traverses it. At step 5, the front traverses the entire gel to produce fully cured thermoset part 18 that maintains its molded shape, and vacuum is removed. At step 6, the thermoset part 18 is separated from the mold.

### Resin Formulation and Characterization

Pot life, the length of time from resin formulation until frontal polymerization can no longer occur, due to reagent decomposition or reaction, is one of the primary considerations for manufacturing with DCPD FROMP systems. To meet the needs of multi-step manufacturing processes such as IME, which demand long pot life (>1 hour), extending pot life of FROMP systems is necessary and an ongoing challenge. See S. Monsaert et al., Chem. Soc. Rev. 38, 3360 (2009); O. M. Ogba et al., Chem. Soc. Rev. 47, 4510 (2018); and B. A. Suslick et al., Macromolecules 54, 5117 (2021). Many proposed solutions involve incorporating inhibitors to reversibly or irreversibly curb catalyst activity. See A. Mariani et al., Macromolecules 34, 6539 (2001); I. D. Robertson et al., ACS Macro Lett. 5, 593 (2016); and A. Ruiu et al., J. Polym. Sci., Part A: Polym. Chem. 52, 2776 (2014). For example, Robertson et al. used alkyl phosphite inhibitors in DCPD resins to extend the liquid state processing window. See I. D. Robertson et al., ACS Macro Lett. 6, 609 (2017). Follow-up work focused on using the stabilized viscoelastic gel state for DIW capabilities and FROMP of free-standing, elastomeric gels. See I. D. Robertson et al., Nature 557, 223 (2018). However, reaching the gel state required long waiting times, limiting throughput. To address this issue, the present invention can use a thermally latent metathesis catalyst, which enables quick formation of elastomeric gels and practical working windows without the need for inhibitors. A commercially available thermally latent ruthenium catalyst, UltraCat (bis(1-(2,6-diethylphenyl)-3,5,5-trimethyl-3-phenylpyrrolidin-2-ylidene)dichloro(3-phenyl-1H-inden-1-ylidene)ruthenium(II)) was used as an example.

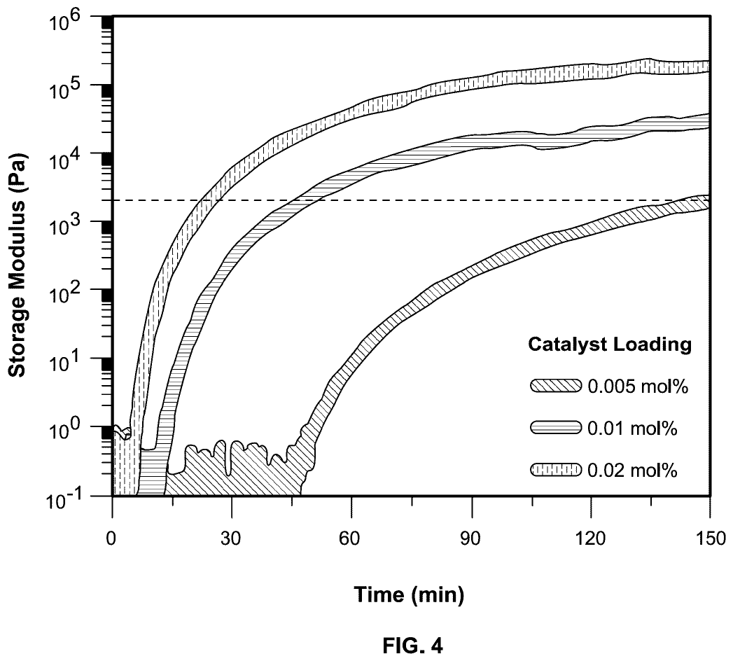

An exemplary DCPD resin comprised the ruthenium catalyst UltraCat, 95 wt % DCPD monomer, and 5 wt % 5-ethylidene-2-norbornene (ENB) comonomer. ENB depresses the crystallization temperature of DCPD and enables stable liquid phase processing at ambient conditions. Initial formulations varied the catalyst loading from 0.005 to 0.04 mol %. Rheological curves, as shown in FIG. 4, characterize the ambient-condition gelation behavior of the resins over time. Modulus crossover represents the time required to reach a viscoelastic gel state, as listed in Table 1. The modulus crossover for 0.02 mol % catalyst occurs approximately 10 minutes after resin preparation. Increasing the catalyst to 0.04 mol % results in a modulus crossover at 5 minutes after resin preparation, limiting the time available for liquid state processing. In comparison, decreasing the catalyst to 0.01 and 0.005 mol % results in a modulus crossover at 20 and 70 minutes after resin preparation, respectively. A catalyst loading of 0.04 mol % does not provide sufficient time for further characterization; therefore, a loading of 0.02 mol % was the maximum explored in the following description.

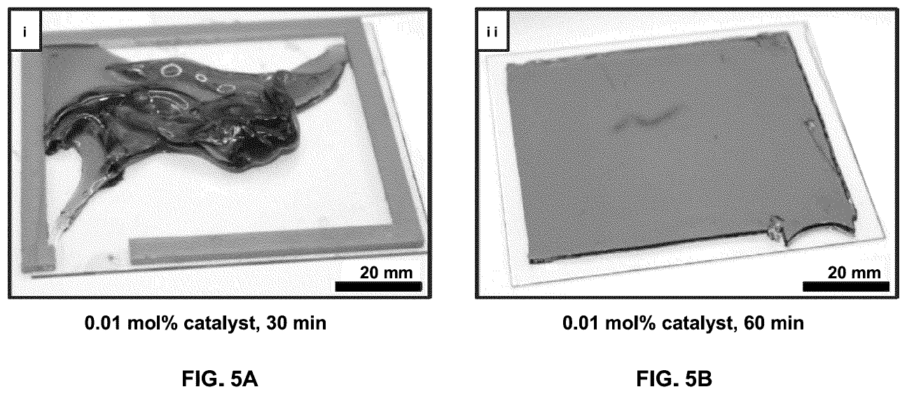

While modulus crossover indicates the initial point of viscoelastic gel formation, it does not clearly signify the formation of a free-standing, elastomeric gel necessary for handling and vacuum forming. Gels are formed by casting resins between two parallel plastic plates spaced to a desired thickness and incubating for a specified duration. Removal of the setting resin from the plates too early—specifically, immediately upon modulus crossover—reveals a tacky, gelatinous solid incapable of maintaining form and causing difficulties in handling, as shown in FIG. 5A. Through investigation, the earliest point at which gels can be easily manipulated by hand corresponds to a storage modulus of about 2 kPa from rheological curves, as shown in FIG. 4 and Table 1. Catalyst loadings of 0.02, 0.01, and 0.005 mol % result in 25, 45, and 150 minutes to reach 2 kPa, respectively. After this, separating the plates results in a usable gel, as shown in FIG. 5B. Therefore, waiting longer enables gels to reach a higher modulus value, improving handling. In general, the storage modulus can be between about 2 kPa (+10%) to about 100 kPa for the gel to be handled without tearing but still allowing for molding and frontal polymerization.

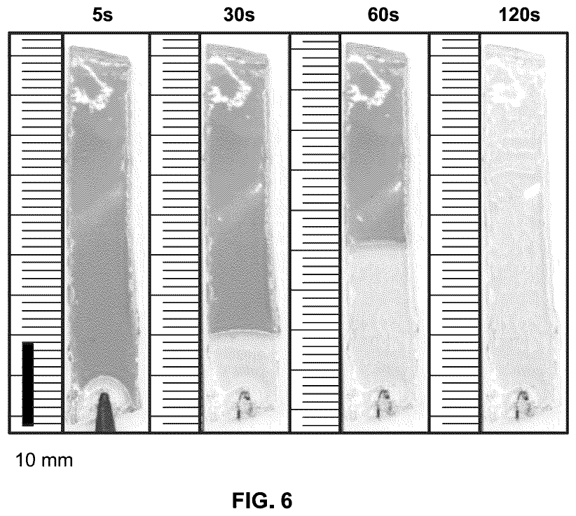

It is desirable that the elastomeric gel remains malleable during the entire manufacturing process without prematurely vitrifying due to background polymerization. To process materials via vacuum forming, the working time (i.e., pot life) of gel must comfortably survive through removal from the plates, transportation to the vacuum former, formation over a mold, and completion of the curing reaction across the entire gel. The working time was characterized for each loading of catalyst by creating a larger gel, removing it from the plates at the time corresponding to reaching 2 kPa from the rheological curves, cutting a moderately-sized strip, and frontally polymerizing the gel by initiating with a heat source (e.g., soldering iron) from one end of the gel strip, as shown in FIG. 6. These strips were tested for their ability to undergo FROMP after removal from the plates and every 15 minutes thereafter until the front no longer propagates the entire length due to lack of significant heat generation. Time points are normalized to the time the gel reaches a 2 kPa storage modulus for each catalyst loading as determined by rheology. For catalyst loadings of 0.02 and 0.01 mol %, the working time of gels was 75 and 90 minutes, respectively. Interestingly, this is in good agreement with the time at which the gels vitrify, or become glassy networks, as observed by parallel plate rheology (Table 1).

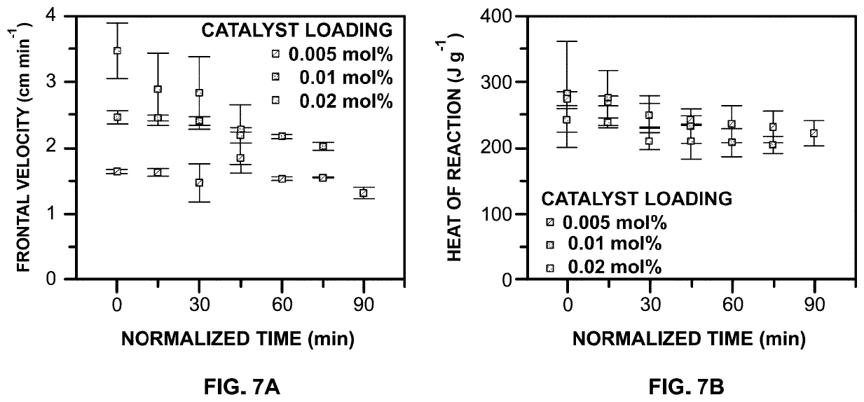

Comparatively, gels containing 0.005 mol % catalyst lose the capacity for FROMP prior to vitrification. This is likely due in part to catalyst death, preventing sufficient exotherm generation at this low catalyst loading. For 0.02 mol % catalyst loading, a window of less than 1 hour (45 minutes) exists between the formation of a usable gel and the end of its working time. Comparatively, catalyst loadings of 0.01 and 0.005 mol % result in more than 1 hour between the usable gel formation and the end of the working time. The temperature and velocity of the front, parameters commonly used to indirectly assess the reactivity of frontal polymerizations, were also evaluated, as shown in FIG. 7A, along with the residual exotherm of the gel as measured by differential scanning calorimetry (DSC), shown in FIG. 7B. At all catalyst loadings, the frontal velocity and the residual exotherm decrease over time, corresponding to the background conversion of DCPD during spontaneous polymerization. See O. Davydovich et al., Macromolecules 56, 7543 (2023); I. D. Robertson et al., ACS Macro Lett. 6, 609 (2017); V. Alzari et al., J. Polym. Sci. Part A: Polym. Chem. 54, 63 (2016); and B. A. Suslick et al., Macromolecules 55, 5459 (2022). At all catalyst loadings, the maximum temperature reached during FROMP remains relatively consistent over time. After undergoing FROMP, all materials were fully cured, as indicated by the lack of a residual exotherm.

A catalyst loading of 0.01 mol % provides many benefits, including a practical 20-minute liquid processing window, rapid 45-minute usable gel formation, and a pragmatic 75-minute working time. Comparatively, a 0.005 mol % catalyst loading requires 150 minutes to form the usable gel phase with little benefit to extended working time and a lower frontal velocity. 0.02 mol % catalyst loading gives quicker usable gel formation (25 minutes) but decreases working time significantly. Therefore, a 0.01 mol % catalyst loading was used for vacuum forming followed by FROMP to enable pDCPD thermoset manufacturing.

TABLE 1
Dynamic gelation behavior of DCPD resins with 0.005, 0.01, and
0.02 mol % catalyst. Usable gel working time corresponds to the
amount of time available between a gel reaching a 2 kPa storage
modulus and the end of its working time (i.e., pot life).

| | | Time to | | | Usable |
|---|---|---|---|---|---|
| | | 2 kPa | | | Gel |
| Catalyst | Modulus | Storage | Time to | | Working |
| Loading | Crossover | Modulus | Vitrification | Pot Life | Time |
| (mol %) | (min) | (min) | (min) | (min) | (min) |
| 0.005 | 70 | 150 | 300 | 240 | 90 |
| 0.01 | 20 | 45 | 105 | 120 | 75 |
| 0.02 | 10 | 25 | 60 | 70 | 45 |

Vacuum Forming and Frontal Polymerization of pDCPD Thermosets

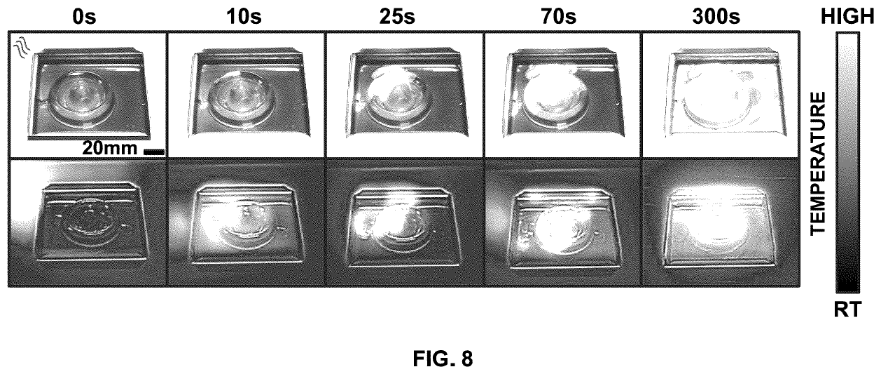

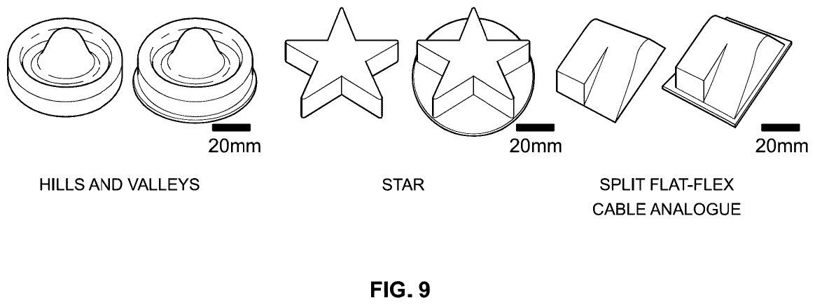

To examine the malleability of the pDCPD gels for use in thermoforming, several geometrically complex molds were additively manufactured for use in vacuum forming. Polymer films were draped over molds and clamped into place on a vacuum table. Enabled by their elasticity, the usable gels successfully vacuum formed to the molds and stretched without rupturing. A heat gun was used to initiate FROMP, as shown in FIG. 8. The front propagation is conveniently visible to the unaided eye by the change in material color from orange to transparent. Thermal imaging further visualizes the high-temperature front traveling across the mold. The time to complete FROMP of the entire 10 cm×10 cm area of the vacuum-forming window was about 5 minutes. After the reaction is completed, the fully cured pDCPD can be separated from the mold and cut to size using a CO₂ laser. This process is amenable to production of parts with distinctive features, including positive and negative curvatures and sharp edges and corners, as shown in FIG. 9. The material was fully cured after the reaction, as indicated by the lack of a residual exotherm from DSC. Therefore, manufactured parts do not require post-processing and are immediately ready for use.

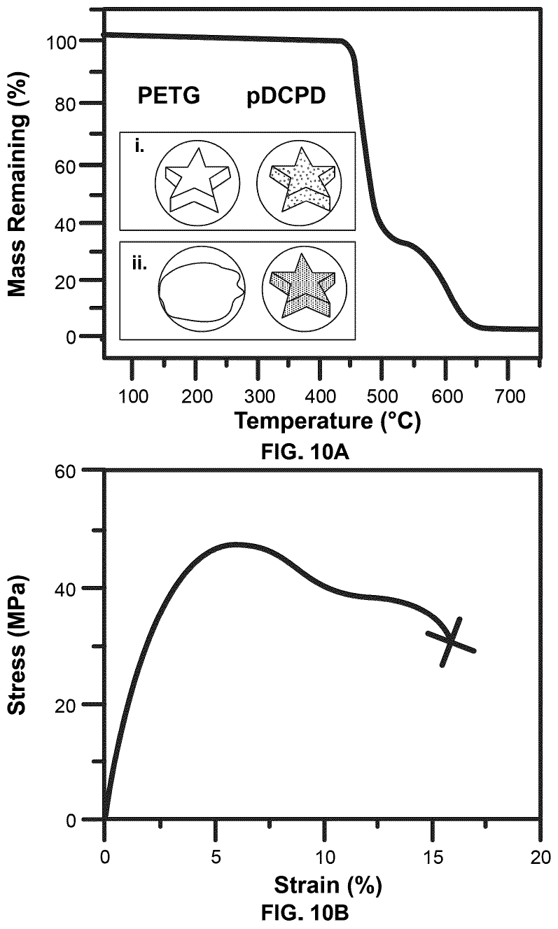

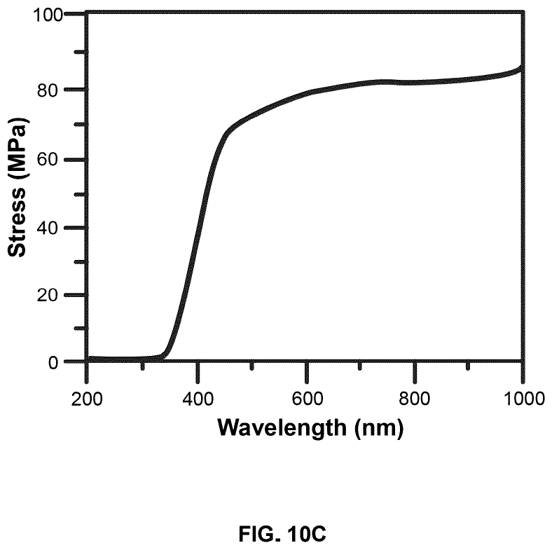

Vacuum forming of thermoset pDCPD results in benefits over traditionally used thermoplastics. Fully cured pDCPD retains mass up to 450° C. before thermally degrading, as characterized by thermogravimetric analysis (TGA), shown in FIG. 10A. Compared to an equivalent thermoplastic part manufactured via traditional vacuum forming, e.g., polyethylene terephthalate glycol (PETG) (FIG. 10A, top inset), pDCPD retains its shape after spending 1 hour at 300° C., while PETG melts and loses shape (FIG. 10A, bottom inset). Notably, the fully cured pDCPD part discolors to dark brown. While oxidation is common in pDCPD materials, this is probably not the singular cause of discoloration due to the experimental conditions within an argon atmosphere. See J. Huang et al., Polym. Degrad. Stab. 166, 258 (2019); V. Defauchy et al., Polym. Degrad. Stab. 142, 169 (2017); J. Huang et al., Polym. Degrad. Stab. 174, 109102 (2020); and E. Richaud et al., Polym. Degrad. Stab. 102, 95 (2014). Instead, discoloration is likely due to degradation or conversion of remaining catalytic species in the material, as indicated by TGA. Nevertheless, the pDCPD part retains its shape.

Fully cured pDCPD manufactured by vacuum forming and FROMP has good mechanical properties, with Young's modulus of 1.7 GPa and tensile strength of 48 MPa, as shown in FIG. 10B. Glass transition temperatures, determined by DMA, are also high, within the range of 168-181° C., as shown in Table 2. Interestingly, the tan delta curve exhibits two distinct peaks, located close together. While the cause of this behavior is uncertain, recent work reports this phenomenon occurring as a function of catalyst selection. See B. A. Suslick et al., Macromolecules 54, 5117 (2021). Regardless, this illustrates the transition of the material from a soft, elastic gel with low glass transition temperature of −18° C. and low Young's Modulus of 39 kPa to a fully crosslinked, tough, glassy network. The materials properties obtained here are comparable to properties for pDCPD reported elsewhere. In addition to its high glass transition temperatures and maximum operating temperatures, pDCPD also exhibits modulus and tensile strength competitive with thermoplastics commonly used for vacuum forming.

TABLE 2
Materials properties of pDCPD vacuum formed containing 0.01
mol % catalyst fully cured (after FROMP) and after exposure
to 300° C. for 1 hour, pDCPD reported in the literature, and
thermoplastics commonly used in vacuum forming processes.
Materials properties of reported pDCPD and thermoplastics
are obtained as averages from MatWeb database of materials
properties unless otherwise noted. Storage modulus and
glass transition temperature T_{g} were determined by
DMA, and ultimate tensile strength from tensile
testing. Tₘₐₓ indicates maximum
operation temperature for parts to maintain
structural integrity. For pDCPD, Tₘₐₓ refers
to degradation temperature. For thermoplastics,
Tₘₐₓ refers to melting temperature.

| | | | | Tensile | | Breakdown |
|---|---|---|---|---|---|---|
| | T_{g} | Tₘₐₓ | Modulus | Strength | Dielectric | Strength |
| Material | (° C.) | (° C.) | (GPa) | (MPa) | Constant | (kV/mm) |
| pDCPD (fully | 168-181 | 450 | 1.7 | 48 | — | — |
| cured) | | | | | | |
| pDCPD (1 hour | 188 | | 1.3 | 45 | — | — |
| at 300° C.) | | | | | | |
| pDCPD | 150 | 400^{a, b} | 2.1 | 54 | 2.5^{c} | ca. |
| (reported) | | | | | | polypropylene^{c} |
| PETG | 81 | 231 | 3.0 | 45 | 2.6 | 18 |
| Polycarbonate | 147 | 282 | 2.3 | 66 | 3.0 | 29 |
| ABS | 108 | 260 | 2.0 | 39 | 3.0 | 33 |
| PMMA | 110 | 227 | 2.9 | 65 | 3.4 | 27 |
| Polystyrene | 90 | 217 | 2.7 | 41 | 2.5 | 77 |
| HDPE | −120 | 127 | 1.0 | 27 | 2.3 | 34 |
| Polypropylene | −20 | 160 | 1.7 | 30 | 2.3 | 130 |

^{a}J. C. Mol, J. Mol. Catal. A: Chem. 213, 39 (2004).
^{b}A. Nickel and B. D. Edgecombe, in Polymer Science: A Comprehensive Reference, pp. 749-759 (2012).
^{c}W. Yin et al, in 2010 IEEE International Symposium on Electrical Insulation, pp. 1-5 (2010).

Exposure of pDCPD to 300° C. for 1 hour in an argon atmosphere resulted in embrittlement of the material, as indicated by tensile testing results. Furthermore, the tan delta curves show a single thermal transition peak centered at 188° C., which could be reflective of increased crosslinking. While oxidative crosslinking is known to occur in pDCPD, it is again doubtful as the singular cause of this phenomenon owing to the inert experimental atmosphere. See D. Dimonie et al., Polym. Degrad. Stab. 67, 167 (2000). Instead, these property changes are likely due to increased crosslinking as a result of olefin addition. See T. A. Davidson and K. B. Wagener, et al., J. Mol. Catal. A Chem. 133, 67 (1998); T. A. Davidson et al., Macromolecules 29, 786 (1996). Regardless, the glass transition temperature remains high, and Young's modulus and tensile strength are largely unaffected, though materials do become embrittled.

Finally, while FROMP-manufactured parts may discolor to light brown over time due to oxidation at the surface, as-made parts are mostly transparent as observed visually and as measured by UV-Vis spectroscopy, as shown in FIG. 10C. Incorporating antioxidants can help to prevent oxidation and discoloration if desired. See M. K. Zamanova et al., “Influence of stabilization recipe on the oxide DCPD formation during thermooxidative aging,” January 2015. However, pDCPD oxidation layers are generally thin (10-100 um) and chemically inert, providing additional benefits such as resistance to bulk oxidation. See S. Kovačič and C. Slugovc, Mater. Chem. Front. 4, 2235 (2020).

Structural in-Mold Electronics Using Thermoset Substrates

As described above, IME currently uses vacuum-formed thermoplastic substrates with applied electronic components followed by injection molding to seal electronics. See M. Bakr et al., Flex. Print. Electron. 7, 023001 (2022). According to the present invention, vacuum forming followed by frontal polymerization enables structural electronics from thermoset substrates, offering benefits such as improved thermal stability and chemical resistance. Furthermore, pDCPD has excellent dielectric properties, offering a promising option for IME. See L. Chen et al., Mater. Lett. 310, 131492 (2022); and W. Yin et al., in 2010 IEEE International Symposium on Electrical Insulation, pp. 1-5 (2010). In current practice, IME uses metal colloid inks that are specifically designed to withstand vacuum forming and injection molding processes to apply conductive traces to substrates. However, these inks incur increased electrical resistance versus bulk metals and are potentially susceptible to aging and lifetime issues (e.g., oxidation), precluding their use in extreme environments. Additionally, conductive traces must withstand FROMP conditions across the pDCPD gel, here reaching temperatures between 150-200° C.

To this end, adhesive-backed copper foils were used to pattern conductive traces. Copper foil traces have been demonstrated previously, in which serpentine patterns are used to accommodate stresses arising from the vacuum forming process. See M. Gonzalez et al., Microelectron. Reliab. 48, 825 (2008); B. Madadnia et al., Int. J. Adv. Manuf. Technol. 119, 6649 (2022); B. Plovie et al., IEEE Trans. Compon. Packag. Manuf. Technol. 9, 955 (2019); B. Plovie et al., Adv. Eng. Mater. 19, 1700032 (2017); and U.S. application Ser. No. 18/652,310. These interconnects can flex in 3D by designing 2D traces with meanders, enabling proper trace placement upon vacuum forming without delamination from the substrate.

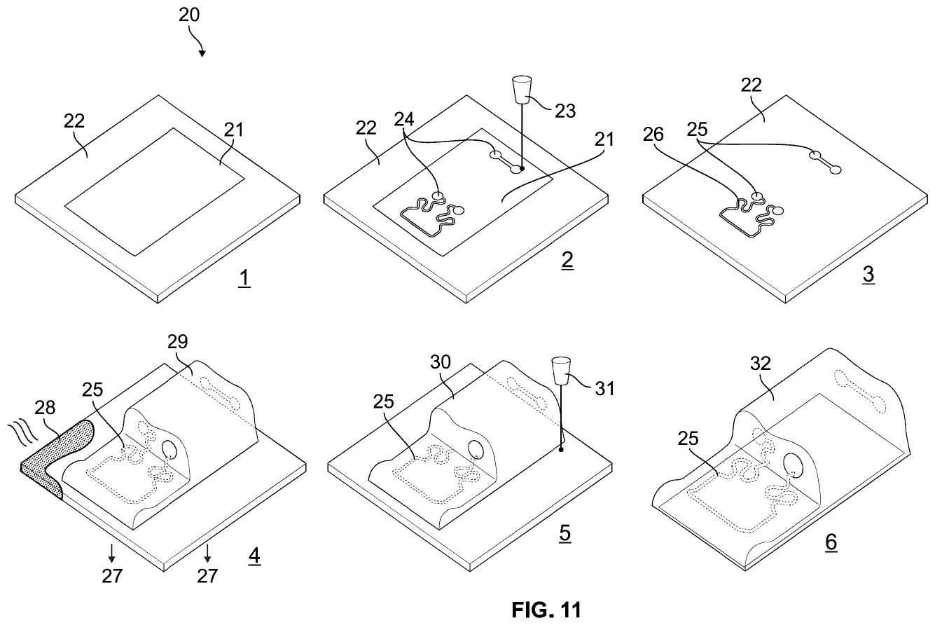

FIG. 11 illustrates a method 20 for fabrication an IME structure using the exemplary pDCPD polymer and copper interconnects. At step 1, copper tape 21 is applied to the pDCPD gel 22. At step 2, a UV laser marker 23 cuts the desired trace design 24 from the copper tape 21. Notably, the UV laser marker 23 enables cold marking, relying on a photolytic degradation mechanism as opposed to pure thermal processing, thereby avoiding initiation of FROMP on the gel 22. Alternatively, traces can be printed directly on the gel using a variety of printing techniques, such as screen printing, lithography, or inkjet printing. Further, other trace materials can be printed, such as other metals, semiconductors, or dielectrics. After cutting the traces, excess copper tape is removed from the gel 22 to leave the conductive copper traces 25 at step 3. The traces 25 can have a meander pattern 26 to reduce strain during vacuum forming. The gel 22 with traces 25 is placed over the mold at step 4, aligning the traces with their desired placement, and vacuum 27 is pulled to vacuum form the gel to the surface of the mold. FROMP 28 is then initiated across the molded gel 29 to form a fully cured pDCPD thermoset 30. Once curing is complete, a CO₂ laser 31 can be used to cut the fully cured thermoset 30 to shape at step 5. Using this method, a structural electronic part 32 can be produced from the fully cured pDCPD thermoset with conductive copper traces 25 at step 6. A variety of surface-mount devices (SMDs) and electronic components can then be attached and connected to the conductive traces to provide electronic functionality. For example, passive devices, such as resistors and capacitors, and active devices, such as chips, sensors, and LEDs, can be placed on the traces using surface mount technology.

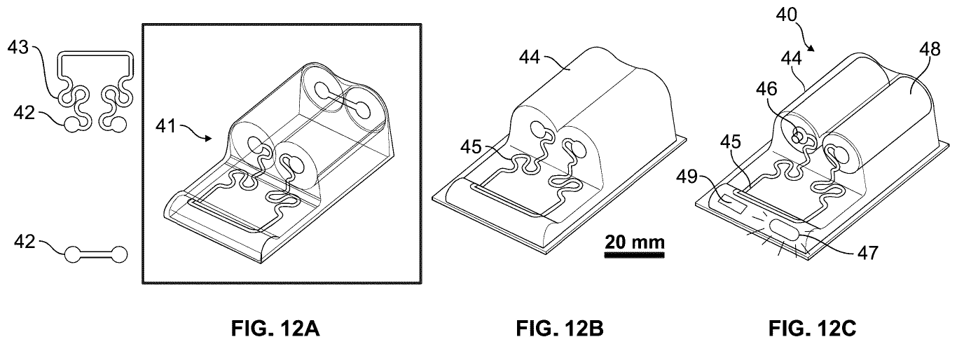

As an example, a battery power module 40 was produced with careful design 41 of traces and mold, as shown in FIG. 12A. This part requires trace placement on the inside of the manufactured part to contact the batteries. Therefore, the gel is formed with interconnect metal traces facing towards the mold. The traces 42 can have a serpentine or meander pattern 43 to reduce strain on the circuitry during vacuum forming. See M. Gonzalez et al., Microelectron. Reliab. 48, 825 (2008). On completion of FROMP and removal from the mold, the fully cured part 44 is successfully generated from the intended design 41 with accurate trace 45 placement, as shown in FIG. 12B. Holes are drilled for the placement of screws and battery spring contacts 46. Furthermore, electronic components, in this case surface mount switches, resistors, and LEDs, can be incorporated onto the trace path afterwards using traditional soldering methods. This is because the thermoset material can tolerate high temperature soldering conditions without risk of deformation. The resulting battery power module 40, shown in FIG. 12C, is a functional device (electrical circuit comprising an LED 47 powered by batteries 48 and operated by a switch 49), illustrating a practical use case for IME.

Thermoset materials can be compatible with accessible vacuum forming processes using frontal polymerization, for example, FROMP of DCPD as described above. The method enables high throughput generation of structural electronics, provides advantageous material properties over traditionally used thermoplastics, and thus can address requirements for operation under extreme (mechanical, temperature) environments. The impact for IME—which seeks to incorporate electronic functions into 3D structural/mechanical objects—is significant, as IME provides greater design freedom while reducing connections between components and overall size, weight and power (SWaP). The development of degradable and recyclable systems and foams using FROMP also offers opportunities for sustainability, part recovery, and mechanical and density tuning within the IME community. See D. M. Alzate-Sanchez et al., Adv. Mater. 34, 2105821 (2022); O. Davydovich et al., Chem. Mater. 34, 8790 (2022); and E. M. Lloyd et al., ACS Appl. Eng. Mater. 1, 477 (2023). Furthermore, the method can be expanded to other thermoset materials systems, including other frontal polymerization reactions, B-staged epoxy resins, dual-cure systems, and covalent adaptable networks. See C. A. Parrinello et al., J. Polym. Sci., Part A: Polym. Chem. 50, 2337 (2012); J. A. Pojman et al., J. Chem. Soc., Faraday Trans. 92, 2825 (1996); D. Bomze et al., J. Polym. Sci. Part A: Polym. Chem. 54, 3751 (2016); S. Bynum et al., J. Polym. Sci. Part A: Polym. Chem. 57, 982 (2019); S. Chen et al., Chem. Mater. 18, 2159 (2006); S. Fiori et al., Macromolecules 36, 2674 (2003); A. Mariani et al., J. Polym. Sci. Part A: Polym. Chem. 42, 2066 (2004); C. Nason et al., Macromolecules 38, 5506 (2005); J. A. Pojman et al., J. Polym. Sci. Part A: Polym. Chem. 35, 227 (1997); W. Zhang et al., Macromolecules 48, 5543 (2015); D. Adrewie et al., J. Polym. Sci. 63, 299 (2024); D. Aelony, J. Appl. Polym. Sci. 13, 227 (1969); D. Budelmann et al., Polym. Test. 114, 107709 (2022); M. B. Roller, Polym. Eng. Sci. 15, 406 (1975); E. Amir et al., in Handbook of Thermoset Plastics (Fourth Edition), pp. 917-929 (2022); O. Konuray et al., Polymers 10, 178 (2018); J. W. Kopatz et al., Addit. Manuf. 46, 102159 (2021); X. Ramis et al., in Thermosets (Second Edition), pp. 511-541 (2018); C. J. Kloxin et al., Chem. Soc. Rev. 42, 7161 (2013); G. M. Scheutz et al., J. Am. Chem. Soc. 141, 16181 (2019); C. J. Kloxin et al., Macromolecules 43, 2643 (2010); and W. Denissen et al., Chem. Sci. 7, 30 (2016). This expansion of materials that are compatible with vacuum forming capabilities represents a breakthrough for IME technologies, enabling 3D device integration into a wider range of durable products, environments, and architectures.

The present invention has been described as in-mold electronics using thermosetting materials. It will be understood that the above description is merely illustrative of the applications of the principles of the present invention, the scope of which is to be determined by the claims viewed in light of the specification. Other variants and modifications of the invention will be apparent to those of skill in the art.

1. A method for fabricating an in-mold electronic structure using a thermosetting polymer, comprising:
providing a resin comprising a metathesis-active olefinic monomer and a latent metathesis catalyst;
transitioning the monomer to an elastomeric gel via a ring-opening metathesis polymerization reaction;
vacuum forming the elastomeric gel to a mold; and
curing the molded gel via a frontal ring-opening metathesis polymerization reaction to provide a thermoset part.

2. The method of claim 1, wherein the metathesis-active olefinic monomer comprises dicyclopentadiene, norbornadiene, or a derivative thereof.

3. The method of claim 1, wherein the resin further comprises a metathesis-active comonomer.

4. The method of claim 3, wherein the metathesis-active comonomer comprises norbornene, oxonorbornene, azanorbornene, cyclobutene, cyclooctene, cyclooctadiene, cyclooctatetraene, or a derivative thereof.

5. The method of claim 1, wherein the latent metathesis catalyst comprises a thermally latent metathesis catalyst.

6. The method of claim 5, wherein the resin comprises between 0.005 and 0.04 mol % of a thermally latent ruthenium catalyst.

7. The method of claim 1, wherein the latent metathesis catalyst comprises a photolatent metathesis catalyst or inhibited catalyst system.

8. The method of claim 1, wherein the elastomeric gel has a storage modulus of greater than about 2 kPa.

9. The method of claim 1, further comprising patterning one or more metal traces on the elastomeric gel after the transitioning step.

10. The method of claim 9, wherein the patterning comprises applying a metal tape to the elastomeric gel, laser cutting a trace design from the metal tape, and removing excess metal tape to leave the one or more metal traces.

11. The method of claim 9, wherein the one or more metal traces comprises an interconnect conductive metal trace having a meander pattern.

12. The method of claim 9, further comprising attaching one or more surface-mount devices to the thermoset part after the curing step to provide an electrical circuit with the one or more metal traces.
